(19) United States
(12) Patent Application Publication
(10) Pub. No.: US 2017/0240084 A1
(43) Pub. Date: Aug. 24, 2017

(54) WALLET RELIEF IN SEAT CUSHION

(71) Applicant: Ford Global Technologies, LLC, Dearborn, MI (US)

(72) Inventor: Gregory Reed, Canton, MI (US)

(73) Assignee: Ford Global Technologies, LLC

(21) Appl. No.: 15/047,846

(22) Filed: Feb. 19, 2016

(51) Int. Cl. B60N 2/70; B60N 2/58

(52) U.S. Cl. CPC B60N 2/70; B60N 2/58

(57) ABSTRACT

A vehicle seat includes a seat member having a support cushion with a first hardness value. A relief member is disposed in the support cushion and has a second hardness value that is less than the first hardness value of the support cushion. The relief member is configured to receive an article that is extending outwardly from a posterior end of the vehicle occupant when the vehicle occupant is supported on the seat member. The seat member is configured to properly support a vehicle occupant in a uniform manner while the outwardly extending article is accommodated by the relief member disposed in the support cushion.

### FIELD OF THE INVENTION

The present invention generally relates to a vehicle seat assembly, and more particularly, to a vehicle seating assembly having a seat member with an integrated relief portion.

### BACKGROUND OF THE INVENTION

Vehicle seating assemblies are configured to support a vehicle occupant in an upright seated position generally using a seat member and back rest member to cradle the vehicle occupant. Many vehicle occupants will keep a wallet or phone, or other like article, in a back pocket of the vehicle occupant's clothing. When seated, the article in the vehicle occupants clothing can cause discomfort by positioning a hard item, such as a wallet or phone, between the vehicle occupant's body and the support surface of the vehicle seat. When a vehicle occupant sits on a wallet or phone located in only the left or right back pocket, the pelvic bone of the vehicle occupant is slightly elevated on one-side which can lead to long term spinal alignment issues, as well as muscle and nerve pain. As such, vehicle occupants are encouraged to remove articles from their rear pockets when the vehicle occupant is to be seated for an extended period of time. This is an inconvenience to the vehicle occupant and seating assemblies providing better comfort are desired to accommodate vehicle occupants in a more ergonomical position.

### SUMMARY OF THE INVENTION

One aspect of the present invention includes a vehicle seat having a seat member that includes a support cushion with a first hardness. A relief member is disposed in the support cushion and has a second hardness that is less than the first hardness of the support cushion. The relief member is configured to receive an article extending outwardly from a posterior end of a vehicle occupant when the vehicle occupant is supported on the seat member. An upper support surface of the seat member is defined by the support cushion.

Another aspect of the present invention includes a vehicle seat have a seat support with a body portion defining an upper support surface. A relief portion is defined by a recess extending downwardly below the support surface and into the body portion of the seat sport. The recess is configured to receive a protruding portion of a posterior end of the vehicle occupant when the vehicle occupant is seated on the seat support.

Yet another aspect of the present invention includes a vehicle seat having a seat member with a first hardness. The seat member includes a receiving recess disposed in one of a rear right quadrant or a rear left quadrant thereof. A relief member is disposed in the receiving recess and comprises a second hardness that is less than the first hardness of the seat member.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a top perspective view of a vehicle seat assembly installed in a vehicle interior according to one embodiment;

FIG. 2 is a top perspective view of the vehicle seat of FIG. 1 removed from the vehicle interior;

FIG. 3A is a fragmentary view of a seat member having a relief portion disposed therein;

FIG. 3B is a fragmentary view of a seat member having a relief portion disposed therein according to another embodiment;

FIG. 4 is a top plan view of a seat member with a seat covering removed to show a padding configuration having a relief portion disposed therein;

FIG. 5A is a cross-sectional view of a vehicle seat assembly wherein the seat member includes a relief portion; and

FIG. 5B is a cross-sectional view of the vehicle seat assembly of FIG. 5A showing a vehicle occupant seated in the vehicle seat assembly.

### DETAILED DESCRIPTION OF THE PREFERRED EMBODIMENTS

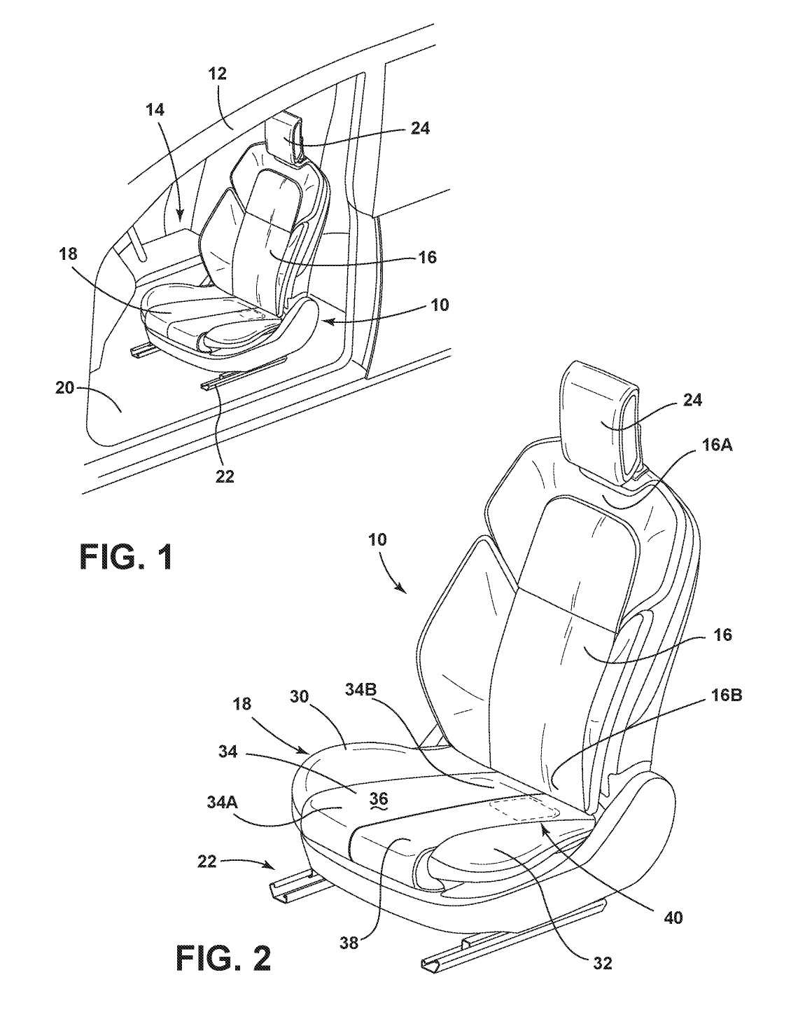

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Referring now to FIG.1, the reference numeral 10 generally designates a vehicle seat assembly as positioned within a vehicle interior 14 of a vehicle 12 on a front driver's side thereof. The vehicle seat 10 includes a seatback 16 which is pivotally coupled to a seat member 18. The seat member 18 is slidably coupled to a vehicle floor 20 along a track assembly 22. The track assembly 22 is configured to allow the vehicle seat 10 to be adjusted in forward and rearward within the vehicle interior 14. It is understood that the vehicle seat 10 may be positioned in various locations throughout the vehicle interior 14 other than the illustrated front driver's side position. As such, the vehicle seat 10 of the present invention can be located in a passenger's side location, a mid-row location, or a rear seat or third row location. It is also conceivable that the vehicle seat 10 may not include a track assembly, like track assembly 22, and alternatively may be fixedly coupled to the vehicle floor 20 at a location within the vehicle interior 14. As further shown in FIG. 1, the vehicle seat 10 includes a headrest assembly 24 supported on an upper portion 16A of the seatback 16.

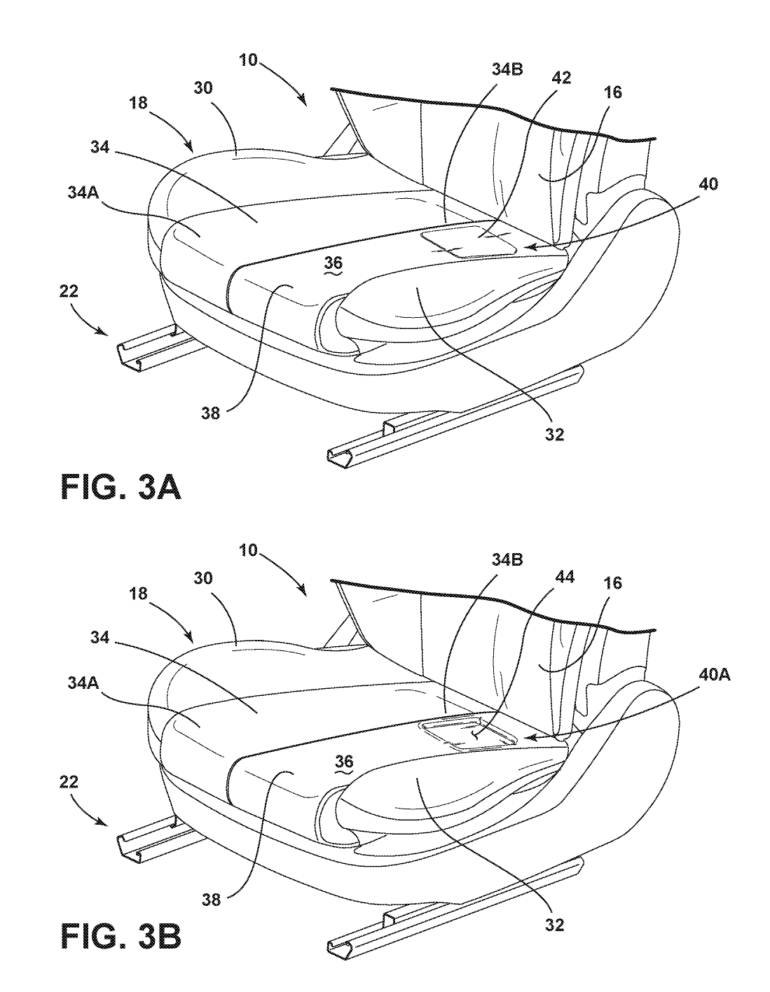

Referring now to FIG. 2, the vehicle seat 10 is shown removed from the vehicle interior 14 of FIG. 1. The seat member 18 of the vehicle seat 10 includes first and second side bolsters 30, 32 which are disposed on opposite sides of and generally angled inwardly towards a central seat support 34 having an upper support surface 36. The central seat support 34 includes a front portion 34A and a rear portion 34B, wherein the rear portion 34B is disposed adjacent a lower portion 16B of the seatback 16 in assembly. A trim cover 38 substantially covers the central seat support 34. In the embodiment shown in FIG. 2, the central seat support 34 includes a relief portion 40 disposed on a left-side (as seated) of the central seat support 34 at the rear portion 34B thereof. While the relief portion 40 is disposed on the left-side of the central seat support 34, it is contemplated that the relief portion 40 may be disposed on any portion of the seat member 18, including the areas covered by the first and second side bolsters 30, 32, the central seat support 34, or any combination thereof. The relief portion 40 is configured to provide relief to a vehicle occupant having an article carried on their person, such as a wallet or phone, wherein the relief portion 40 accommodates an article protruding from a posterior end of the vehicle occupant when the vehicle occupant is seated in the vehicle seat 10.

With further reference to FIG. 2, the seat member 18 is configured such that the central seat support 34 defines a thigh support at the front portion 34A thereof and a posterior end support at the rear portion 34B thereof. Thus, with the relief portion 40 disposed in the posterior end support section at the rear portion 34B of the central seat support 34, the relief portion 40 is suitably positioned to accommodate an article protruding from a posterior end of the vehicle occupant in a seated position.

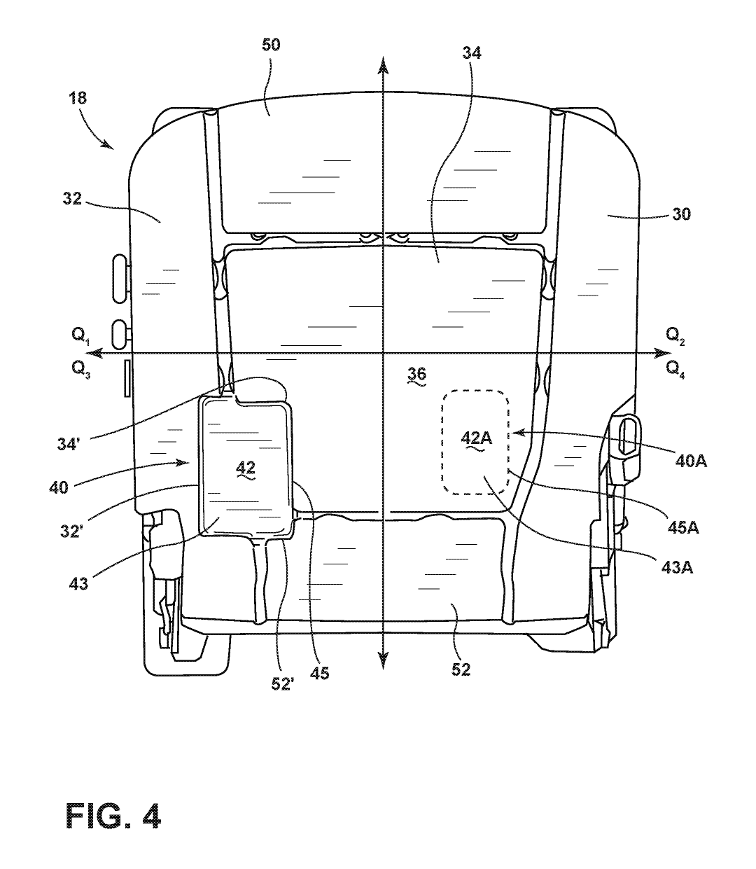

Referring now to FIG. 3A, the seat member 18 is shown with the relief portion 40 disposed in the rear portion 34B of the central seat support 34. The relief portion 40 includes an upper receiving surface 42 that is substantially planar with the upper support surface 36 of the central seat support 34 in an at-rest condition. While the image in FIG. 3A has the relief portion 40 outlined on the central seat support 34, it is contemplated that the upper support surface 36 may be covered by a seat cover that covers both the central seat support 34 and the relief portion 40 in a unitary manner, such that the relief portion 40 is substantially concealed in assembly. As such, the receiving surface 42 may be an integrated part of the upper support surface 36 of the seat member 18.

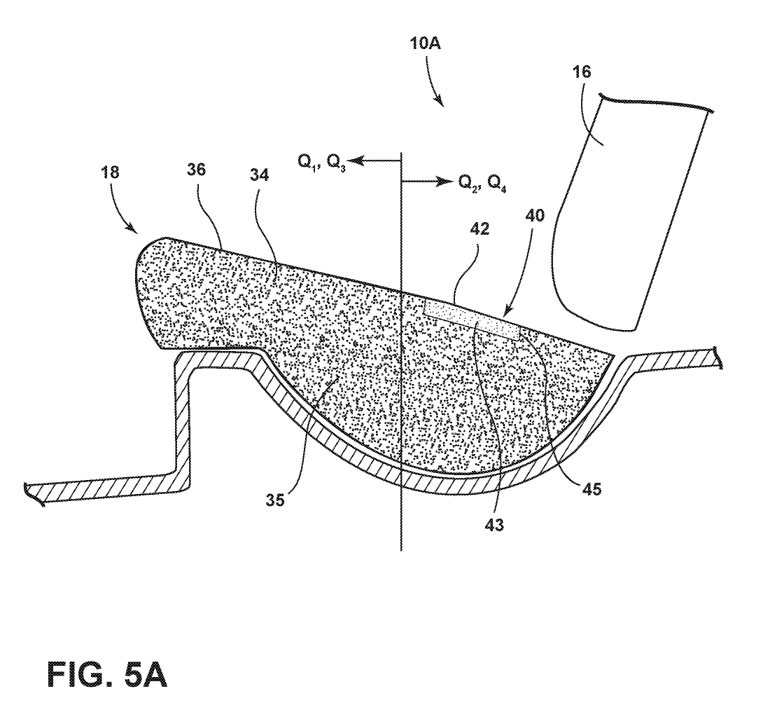

As noted above, the relief portion 40 is configured to provide relief to a vehicle occupant by receiving a protruding portion of a posterior end of the vehicle occupant when the vehicle occupant is seated and supported on the seat member 18. The relief portion 40 may provide for a uniform upper support surface 36 when the relief portion 40 comprises a flexibly resilient relief member disposed in a receiving recess of a seat cushion as further described below with reference to FIG. 4. The relief member includes a density or hardness that is less than the hardness of the component parts of the seat member 18, such that a protruding article from a posterior end of a vehicle occupant will easily be received in the relief member, and the vehicle occupant will have substantially uniform support over the seat member 18.

Referring now to FIG. 3B, the seat member 18 is shown with a relief portion 40A according to another embodiment of the present concept. In the seat member 18 of FIG. 3B, the relief portion 40A is a recess disposed within the rear portion 34B of the central seat support 34. The recess, identified as reference numeral 44, may be substantially concealed under the trim cover 38, such that the upper support surface 36 of the seat member 18 will have a substantially uniform appearance. The recess 44 is configured to receive an article protruding from a posterior end of a vehicle occupant while seated on the seat member 18. Thus, as compared to a flexibly resilient relief member, the recess 44 receives the protruding article, as opposed to a relief member having a suitable hardness or density for accommodating a protruding article, as further described below.

Referring now to FIG. 4, the seat member 18 is shown having a plurality of cushions for supporting a vehicle occupant in a seated position. Specifically, the seat member 18 shown in FIG. 4 includes the first and second side bolsters 30, 32 and central seat support 34 which are cushioned materials configured to support the vehicle occupant. In the embodiment shown in FIG. 4, the seat member 18 further includes a front cushion 50 and a rear cushion 52. The front cushion 50 is contemplated to support the thighs of a seated vehicle occupant, while the rear cushion 52 is contemplated to support a posterior end or buttocks region of the seated vehicle occupant, along with central seat support 34. In the embodiment shown in FIG. 4, the seat member 18 is divided into four quadrants Q1-Q4, wherein Q1 and Q2 make up front left and front right quadrants, respectively, and quadrants Q3 and Q4 make up rear left and rear right quadrants, respectively. The relief portion 40 is shown in FIG. 4 as a relief member 43 disposed in a receiving recess 45 of the seat member 18. The receiving recess 45 is partially defined by perimeter portions 34′, 32′ and 52′ of the central seat support 34, the second side bolster 32 and the rear cushion 52, respectively. The receiving recess 45 is shown in FIG. 4 as being defined between several different cushions within the seat member 18, however, it is contemplated that the receiving recess 45, and the relief member 43 received therein, may be fully disposed within any one cushion, and particularly within the central seat support 34. Whether the relief member 43 is disposed in a single cushion or among a plurality of cushions, the relief member 43 is contemplated to be disposed in one of the rear quadrants Q3 or Q4. In FIG. 4, the relief member 43 is disposed in the third quadrant Q3 which is a rear left quadrant, but may also be disposed in the rear right quadrant Q4 depending on the side within which a vehicle occupant may store a protruding article, such as a phone or wallet.

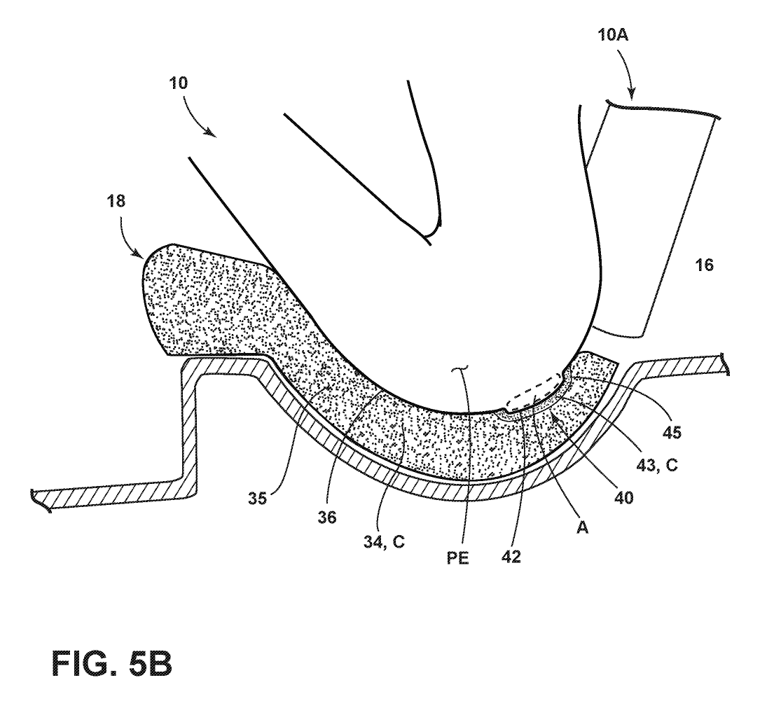

As noted above, the cushions of the seat member 18 are contemplated to be cushion materials that can have various hardness values. Particularly, the cushions of the seat member 18 are contemplated to be comprised of an expandable foam material, such as polyurethane, that can be molded into a desired shape for properly supporting a vehicle occupant. Particularly, the first and second side bolsters 30, 32, the central seat support 34, and the front and rear cushions 50, 52 may include a substantially similar hardness in a range of about 150 to about 400 newtons. Such a hardness value can be measured by indentation force deflection (IFD) as measured by ASTM test method number D3574. With an initial range of about 150 to about 400 newtons for uninstalled cushions, the cushions of the seat member 18 can properly support a vehicle occupant. The hardness of the cushions is increased as the seat member 18 is assembled and trimmed out, such that in assembly, the cushions of the seat member may include a hardness range of about 200 to about 450 newtons in assembly. The relief member 43 is contemplated to have a composition with a lower hardness value as compared to adjacent cushions in the seat member 18. In this way, the relief member 43 can accommodate a protruding article disposed at a posterior end of the vehicle occupant in a seated position without compromising the alignment of the vehicle occupant as supported on the seat member 18. Thus, the relief member 43 is contemplated to have a hardness value that is below 150 newtons. Specifically, the hardness of a foam relief member 43 may be in a range from about 80 to about 140 newtons and comparable to a soft memory foam cushion. In this way, the seat member 18 has a composition that is varied in density or hardness across the seat member 18, such that the relief portion 40 is disposed in an area for receiving a protruding article, and has a hardness value suitable to accommodate such an article, as further shown and described below with reference to FIG. 5B.

As further shown in FIG. 4, a relief portion 40A includes a relief member 43A that is shown in phantom as being disposed within a receiving recess 45A that is fully disposed within the central seat support 34 in the rear left quadrant Q4 of the seat member 18. While this relief portion 40A is shown in phantom, it is contemplated that the relief portion 40A can be positioned as shown in FIG. 4 for accommodating a vehicle occupant that keeps a wallet of phone in a rear right pocket while seated on the seat member 18.

Referring now to FIG. 5A, a vehicle seat assembly 10A is shown as a rear passenger seat for a vehicle. The vehicle seat assembly 10A includes a seat member 18 and a seatback 16 with a generally centrally disposed seat support 34 having an upper support surface 36. A receiving recess 45 is disposed downwardly below the support surface 36 within a body portion 35 of the seat support 34, and a relief member 43 is disposed within the receiving recess 45 and includes an upper receiving surface 42. In this way, the relief member 43 defines a relief portion 40 for the seat member 18. The seat support 34 is contemplated to have a first hardness value that is greater than a second hardness value of the relief member 43. In this way, the relief member 43 can accommodate a protruding article from a posterior end of a vehicle occupant, while the seat support 34 can properly support a vehicle occupant as better shown in FIG. 5B. With further reference to FIG. 5A, the upper support surface 36 of the seat support 34 is shown as being aligned with the receiving surface 42 of the relief member 43 to provide a generally uniform seat support surface for the seat member 18 when the seat support 34 and relief member 43 are in at-rest conditions.

Referring now to FIG. 5B, a vehicle occupant VO is shown in a seated position on the seat member 18. A posterior end PE of the vehicle occupant VO is shown positioned generally on the seat support 34, such that the seat support 34 is shown in a compressed condition C. An article A is shown protruding or outwardly extending from the posterior end PE of the vehicle occupant VO and is shown as being aligned with the relief member 43 of the seat member 18. The relief member 43 is also in a compressed condition C in FIG. 5B. With the article A protruding outwardly from the posterior end PE of the vehicle occupant VO, the article A imparts a force on the relief member 43 to compress the relief member 43 to the compressed condition C. As noted above, the relief member 43 is flexibly resilient and has a hardness that is less than the hardness of the seat support 34. Thus, the receiving surface 42 of the relief member 43 is disposed below an upper boundary defined by the support surface 36 of the seat support 34 as urged thereto by a force imparted by the article A. In this way, the vehicle occupant VO is uniformly supported by the seat member 18 and the article A is accommodated by the relief portion 40. In the embodiment show in FIG. 5B, the relief portion 40 includes a flexibly resilient relief member 43 having a hardness that is less than the hardness of the seat support 34. Thus, the relief member 43 will compress a greater distance as compared to the seat support 34 when an equal force is applied thereto, given the varying hardnesses. It is further contemplated that the relief portion 40 may be a void or recess of its own which is configured to receive the article A in the posterior end PE of the vehicle occupant VO. In such a configuration, the article will be received in the recess, much like recess 44 shown in FIG. 3B, and no actual relief member or relief cushion will be part of the relief portion 40.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

1. A vehicle seat, comprising:
a seat member having a support cushion with a first hardness;
a relief member disposed in the support cushion having a second hardness that is less than the first hardness of the support cushion and configured to receive an article extending outwardly from a posterior end of a vehicle occupant when supported on the seat member; and
an upper support surface defined by the support cushion.

2. The vehicle seat of claim 1, wherein the relief member includes a receiving surface disposed at an upper portion thereof.

3. The vehicle seat of claim 2, wherein the support surface of the support cushion is substantially planar with the receiving surface of the relief member in an at-rest condition.

4. The vehicle seat of claim 3, wherein the receiving surface of the relief member is disposed below the support surface of the support cushion in a compressed condition by a force imparted by the article.

5. The vehicle seat of claim 1, wherein the seat member includes first and second side bolsters disposed on opposite sides of the support cushion and angled inwardly towards the support cushion.

6. The vehicle seat of claim 5, wherein the first and second side bolsters include a hardness that is substantially similar to the first hardness of the support cushion.

7. The vehicle seat of claim 1, wherein the first hardness of the support cushion includes a hardness value in a range from about 200 to about 450 newtons.

8. The vehicle seat of claim 7, wherein the second hardness of the relief member includes a hardness value in a range from about 80 to about 140 newtons.

9. The vehicle seat of claim 1, wherein the first hardness of the support cushion includes a hardness value in a range from about 200 to about 450 newtons, and further wherein the second hardness of the relief member includes a hardness value that is less than 200 newtons.

10. A vehicle seat, comprising:
a seat member having a body portion defining an upper support surface; and
a relief portion defined by a recess extending downwardly below the upper support surface and into the body portion of the seat member, wherein the recess is configured to receive a protruding portion of a posterior end of a vehicle occupant when the vehicle occupant is seated on the seat member.

11. The vehicle seat of claim 10, including:
a trim cover disposed over the seat member and substantially covering the relief portion.

12. The vehicle seat of claim 10, wherein the seat member comprises four quadrants including a front left quadrant, a front right quadrant, a rear left quadrant and a rear right quadrant.

13. The vehicle seat of claim 12, wherein the relief portion is disposed in the rear left quadrant.

14. The vehicle seat of claim 12, wherein the relief portion is disposed in the rear right quadrant.

15. A vehicle seat, comprising:
a seat member having a receiving recess disposed in one of a rear right quadrant and a rear left quadrant thereof; and
a trim cover disposed over the seat member and covering the receiving recess.

16. The vehicle seat of claim 15, wherein the relief member is configured to receive a protruding portion of a posterior end of a vehicle occupant when the vehicle occupant is seated on the seat member.

17. (canceled)

18. (canceled)

19. (canceled)

20. (canceled)

21. The vehicle seat of claim 16, wherein the seat member includes first and second side bolsters disposed on opposite sides of the seat member and angled inwardly towards the seat member.

22. The vehicle seat of claim 15, wherein the seat member is comprised of a plurality of cushions.

23. The vehicle seat of claim 22, wherein the receiving recess is defined by cutout portions of multiple cushions of the plurality of cushions.

24. The vehicle seat of claim 12, wherein each quadrant of the four quadrants are comprised of a plurality of cushions.

25. The vehicle seat of claim 24, wherein the relief portion is defined by outer perimeter portions of more than one cushion.
